(19) United States
(12) Patent Application Publication
(10) Pub. No.: US 2025/0086836 A1
(43) Pub. Date: Mar. 13, 2025

(54) METHOD OF PERSONAL COLOR ANALYSIS USING A 16 COLOR CATEGORY SYSTEM

(71) Applicant: Ferial Youakim, Lauderdale By The Sea, FL (US)

(72) Inventor: Ferial Youakim, Lauderdale By The Sea, FL (US)

(21) Appl. No.: 18/533,021

(22) Filed: Dec. 7, 2023

Related U.S. Application Data
(60) Provisional application No. 63/582,419, filed on Sep. 13, 2023.

(51) Int. Cl. G06T 7/90; G06V 10/56; G06V 10/764

(52) U.S. Cl. CPC G06T 7/90; G06V 10/56; G06V 10/764

(57) ABSTRACT

A method of using a color classification system which includes providing a color classification system including categorized colors organized in 16 color categories, selecting a personality type of an individual by identifying skin tone and personality characteristics of the individual and providing an analysis of skin undertone, skin tone intensity, hair color and eye color of the individual. The method includes using the personality type and the analysis for determining a target color category of the 16 colors categories matches the individual and using the color classification system for implementing the target category for color selection for the individual. The method may be replicable and teachable method of using a color classification system. The method may be taught to trainees for management or customer care. The method may be replicated in a franchise. The target color category may be used to target colors for one or more apparel.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### REFERENCE TO RELATED APPLICATIONS

This application is a Non-Provisional Utility Patent application claiming priority to U.S. Provisional Patent application Ser. No. 63/582,419, filed on Sep. 13, 2023, the application of which is incorporated by reference herein in its entirety.

### BACKGROUND OF THE INVENTION

### 1) Field of the Invention

The invention relates in general to the field of color selection, and more particularly, to color selection pertaining to characteristics of an individual. The invention pertains to a method of using a 4×4 color system for personalized color selection based on an individual's skin tone, hair color, eye color, and personality DNA.

### 2) Description of Related Art

Isaac Newton is the person who started the color theory and created the color wheel in 1671. Then Albert Munsell carried on and refined what Sir Isaac Newton did and created the color system in 1905. In 1928 Johannes Itten discovered the relationship between color preference, personality, and appearance. Ferial Youakim created the 4×4 Color System (16 Seasons) @ in 2000 that flipped the color wheel by adding white, black and gray to add Light, Muted and Shaded tones to the original 12 seasons pure colors.

In a chronological list of background information: 2010: ByFerial (Ferial Youakim) applied and was approved by the Australian government for R&D funding to develop a more complete color analysis, taking the color analysis process from 12 to 16 seasons. The new system was trademarked as the Universal 4×4 Color System (16 season®); 2017: ByFerial released Evolution Of Color eBook, to help individuals discover the colors that brought out their inner beauty and confidence; 2022: ByFerial color certification courses using the 4×4 Color Analysis and 16 Seasons System® was officially approved and accredited by ANSI/IACET, the International Accreditors for Continuing Education and Training. ByFerial is the ONLY accredited image and color consultant training course in the world.

An individual's skin color and personality DNA is something they are born with and that cannot be changed until the individual's personal color naturally changes and becomes softer and lighter with age. Their skin and color personality DNA affects all aspects of an individual's life from their inner well-being to their purchases to their lifestyle. If businesses can understand the science behind the skin and color personality DNA, that information can be used to change and revolutionize their business.

Color psychology is concerned with the emotional and psychological effects of different colors. It investigates how colors can influence our moods, behaviors and even our health. Color psychology is a field of experimental psychology that explores how color affects our perceptions, cognition and behavior. While color analysis strives to understand the psychological effects of color, color psychology seeks to explain why those effects occur.

In the field of personal styling and interior design, color plays a significant role. It is well known that different colors can evoke different emotions and reactions and can even influence a person's mood and overall perception. Therefore, it is crucial to choose the right colors for clothing and décor that suit an individual's personality and physical attributes.

Traditionally, color selection has been a subjective process, often based on personal preference or the latest fashion trends. However, this approach can lead to unsatisfactory results, as the chosen colors may not necessarily complement the individual's skin tone, hair color, and eye color. Furthermore, the individual's personality, which can significantly influence their reaction to different colors, is often overlooked in the color selection process.

There are color systems available that categorize colors into different seasons, but these systems typically only consider the individual's physical attributes and do not take into account their personality. Moreover, these systems usually only offer a limited number of seasons, which may not accurately represent the wide range of human skin tones and personalities.

Therefore, there is a need for a more comprehensive and personalized approach to color selection that considers both the physical attributes and the personality of the individual.

These and other objects, features, and advantages of the present invention will become more readily apparent from the attached drawings and the detailed description of the preferred embodiments, which follow.

### SUMMARY OF THE INVENTION

Bearing in mind the problems and deficiencies of the prior art, it is therefore an object of the present invention to provide a revised approach to color analysis by adding a person's skin color and DNA to the analysis. The process is the Revolution Of Color: a ‘4×4 Color Methodology’ to educate businesses and individuals to enhance their color analysis process. The method using this methodology impacts the individual, businesses, and the planet.

In accordance with embodiments, a method is provided for using a color classification system. The system includes categorized colors organized in 16 color categories. The personality type of an individual is determined by identifying the individual's skin tone and personality characteristics. The personality type determination is used along with the analysis of the skin undertone, skin tone intensity, individual's hair color and individual's eye color to provide color matching results. These results are used to determine which one out of 16 color categories matches the individual. The selected color category is then used to better target colors for one or more apparel and one or more interior design elements selection for the individual.

In accordance with other embodiments, a system is provided for using a color classification system. The system comprises modules for providing a color classification system, determining the personality type of an individual, using the personality type determination and analyzing the skin undertone, skin tone intensity, individual's hair color and individual's eye color to provide color matching results, using the color matching results to determine which one out of 16 color categories matches the individual, and using the selected color category to better target colors for one or more apparel and one or more interior design elements selection for the individual.

Still other objects and advantages of the invention will in part be obvious and will in part be apparent from the specification.

The above and other objects, which will be apparent to those skilled in the art, are achieved in the present invention which is directed to a method of using a 4×4 color system, the 4×4 color system including seasonal colors which are organized in 16 seasons. The method includes determining if the personality of an individual is active or passive by identifying skin color and personality DNA of the individual. The method includes using the active or passive determination and analyzing the undertone hue and intensity of the skin tones, hair color and eye color of the individual to provide color analysis results. The color analysis results are used to determine which one season of the 16 seasons matches the individual. The one season allows better targeting of colors for clothing and décor selection for the individual. Specific seasonal colors are provided in the drawings included herewith.

The strategies and tools used in the method described herein target the fashion industry, makeup industry, hair and beauty industry, and design industry; and can be applied to many other industries that can benefit from the psychology of skin and color DNA analysis.

Another aspect of the present invention is directed to a method of using a color classification system. The method includes providing a color classification system including categorized colors organized in 16 color categories, selecting a personality type of an individual by identifying skin tone and personality characteristics of the individual, providing an analysis of skin undertone, skin tone intensity, hair color and eye color of the individual, using the personality type and the analysis for determining a target color category of the 16 colors categories matches the individual and using the color classification system for implementing the target category for color selection for the individual. The method may be replicable and teachable method of using a color classification system. The method may be taught to trainees for management or customer care. The method may be replicated in a franchise. The target color category may be used to target colors for one or more apparel. The target color category may be used to target colors for one or more interior design elements selection for the individual. The personality type of an individual may be determined as active or passive and the method may include using the active or passive determination in analyzing the undertone hue and intensity of the skin tones, hair color and eye color of the individual to provide color analysis results. The color classification system may be a 4×4 color system. The color matching results may be based on the analysis of the undertone hue and intensity of the skin tones, hair color and eye color of the individual. The target color category may be used to determine season matches for the individual's personality and physical characteristics. The color classification system may include seasonal colors organized in 16 seasons. The color matching results may be used to provide personalized color recommendations for the individual. The steps of selecting a personality type of an individual by identifying skin tone and personality characteristics of the individual and providing an analysis of skin undertone, skin tone intensity, hair color and eye color of the individual may be reversed.

Another aspect of the present invention is directed to a system for using a color classification system. The system includes a module for providing a color classification system including categorized colors organized in 16 color categories, a module for determining the personality type of an individual by identifying the individual's skin tone and personality characteristics, a module for using the personality type determination and analyzing the skin undertone, skin tone intensity, individual's hair color and individual's eye color to provide color matching results, a module for using the color matching results to determine which one out of 16 color categories matches the individual and a module for using the selected color category for targeted color selection for the individual. The system may target colors for one or more apparel and one or more interior design elements selection for the individual. The personality type of an individual may be determined as active or passive. The color classification system may be a 4×4 color system. The color matching results may be used to target colors for clothing selection for the individual. The color matching results may be used to target colors for décor selection for the individual. The color matching results may be based on the analysis of the undertone hue and intensity of the skin tones, hair color and eye color of the individual.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows color palates relating to the method for using the 4×4 color system according with corresponding color tabs in fan presentation;

FIG. 2 shows a flowchart of a first method of using the 4×4 color system according to the present invention;

FIG. 3 is a diagram showing flow of a 4×4 color system according to the present invention;

FIG. 4 shows a flowchart of another embodiment of a method of using the 4×4 color system according to the present invention; and

FIG. 5 is a diagram showing another embodiment of the flow of a 4×4 color system according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Prior to a discussion of the preferred embodiment of the invention, it should be understood that while the features and advantages of the invention are illustrated in terms of a 4×4 color system using a 16 seasons scheme.

An individual's personality & skin DNA are a key factor in determining their seasonal colors using the Universal 4×4 Color System—16 Seasons®.

The inventor is a color authority on the 4×4 Color System according to the present invention. The system is a method of using the 4×4 color system to analyze the undertone hue and intensity of people's skin tones, hair and eye color to determine which of the (16 Seasons)® the individual matches. Color is scientifically proven to affect human behavior. The new Revolution Of Color introduces individuals and businesses to a new process that includes the psychology of skin and color DNA: energy, personality, appearance, confidence and creativity.

Identifying an individual's skin color and personality DNA will show if the person's personality is active or passive. This information is important for image consultants that work with fashion brands, to better target and influence potential customers to make the right decision for their clothes, and it is equally important for industries that want to enhance the overall well-being of an individual in their daily life.

Listed are some of the physical and personality trait details of the Active/Yang Personality:
Vibrant Presence: Individuals embodying Yang/Active traits command attention due to their strong and striking appearance, whether through their choice of clothing, bold colors, or expressive gestures.
Assertive and Energetic: They carry an animated demeanor, exuding palpable energy. Their assertive attitude and strong voice make them comfortable in leadership roles and being the center of attention.
Confidence and Strong Personality: Yang/Active individuals possess an outgoing nature, exuding confidence and often taking charge in various situations.
Yang/Active and Color Choice: Active personalities are drawn to brighter, bolder, and darker colors, resonating with their vibrant energy. Vivid reds, bold blues, deep purples, or striking yellows reflect their outgoing nature and strong presence.

When the Active/Yang person wears colors that mirror their personal energy, they stand out uniquely, shining in their own way.

Listed are some of the physical and personality trait details of the Passive/Yin Personality:
Subtle Presence: Yin/Passive individuals have a more subdued presence, blending in due to their softer and quieter demeanor.
Deliberative and Considerate: They approach decision-making with care and have a gentle, considerate manner in their interactions, often observing before actively engaging.
Reserved and Calm: Yin/Passive individuals move at a slower pace, preferring a more reserved personality. They avoid seeking the spotlight and opt for a low-key approach in social situations.
Passive/Yin and Color Choice: Passive personalities favor lighter, softer, and muted colors that align with their gentle demeanor. Pastel shades, lighter blues, pinks, greens, or neutral tones like beige and soft grays suit them, reflecting tranquility and subtlety.

When the Passive/Yin person wears colors that echo their personal energy, it not only conveys their soft colors but also resonates with their gentle soul.

Understanding how color choices align with personality traits helps individuals express themselves authentically. However, personal color preferences vary widely, and not everyone strictly follows these associations. The system utilizes the 4×4 system and the 4-step method in order to align the individual skin and color personality DNA tastes and contexts in which colors are chosen. It is important to note that these descriptions are generalizations; individuals often exhibit a blend of both active and passive traits due to various factors such as diverse backgrounds, marriages, and evolving societal norms.

The method of using the 4×4 color system is used in a system to train businesses, industry professionals and individuals in how the correct application of color analysis impacts an individual's personality so they can:
Improve an individual's outward appearance.
Enhance the inner well-being, mood, attitude and self-confidence of an individual
Helping individuals grow their business and increase their profits
Protect the environment by focusing on sustainability and decreasing waste by minimizing color mistakes in fashion, makeup, decor, and other personal and lifestyle products.

The Revolution Of Color is a teachable, replicable system that adds the science of color psychology DNA to the 4×4 Color system to influence behaviors and feelings.

The Revolution Of Color provides measurable and meaningful information that enables business and personal decisions that carry significant impacts.

### Case Study: Revolution of Color is Teachable and Replicable

A ByFERIAL consultant was trained by Ferial Youakim and implemented the Revolution of Color for her shop and online boutique. As a trained, experienced color and image consultant, she immediately understood the power and benefits behind the Revolution Of Color and she applied the new process to test the methodology.

As “a steward for maintaining the health of our environment,” a volunteer water quality monitor and a member a river conservancy, she understands and appreciates the importance of sustainability and environmental benefits of eliminating waste due to purchase mistakes.

This case study is a model for how the concepts and methods of The Revolution Of Color can be replicated globally.

BRANDS: For brands that could understand their customers' color psychology, they can influence and educate them to wear the color, paint the house, or choose the flowers that will impact them on the inside, and the outside. When a brand understands how the customers' Inner color personality is linked to their outer appearance and decision making, they can use that information to grow their business and their profits.

BUSINESSES: A service business that understands its clients' color psychology can educate and influence its clients to make purchases, build marketing strategies and make business decisions using the psychology of color. Strategically implementing the methodology and principles of color psychology for clients and customers will lead to
Business growth
Business profitability
Client satisfaction

INDIVIDUALS: With mental health at an all-time crisis, inner well-being and self-confidence are vital to personal happiness and success. When an individual understands the psychology of skin color and personality DNA, they can make better decisions about color choices that impact their daily life and well-being. When individuals understand and practice the principles of color psychology for their own purchases and lifestyle decisions they will
Experience feelings of inner well being
Have self-confidence in their outer appearance.
Save money by reducing waste on purchases that don't complement and enhance their person or home.
Reduce stress in making important personal and family decisions such as hair color, clothing, furnishings, paint colors and other color-related decisions.
Reduce waste by not contributing to the environmental issues caused by excessive waste

PLANET SUSTAINABILITY: Individuals and brands that use color psychology can effectively combat the pressing global issues of clothing, personal care products and decor over-supply and wastage. Many consumers make bad purchases and choose colors that don't complement their outer appearance or inner self-confidence and well-being. This can include “fast fashion,” makeup, home decor and other purchase decisions.

By harnessing the power of enhanced customer data insights and establishing direct business-to-consumer channels, Revolution Of Color enables retailers and manufacturers to create, produce, purchase and market fashion and personal care and home decor products with unparalleled efficiency and sustainability and environmental. Particularly for younger, highly environmentally aware consumers, the psychology of color DNA is a cutting-edge solution that paves the way for a brighter, greener and more prosperous future for all.

Books by inventor Ferial Youakim which are hereby incorporated by reference:
2023: Revolution of Color.
2017: Beyond Beauty: A Refugee's Journey in Pursuit of Happiness
2014: Evolution of Color: 4×4 Color System
2010: The Universal 4×4 Color System—16 Seasons.
2008: How To Choose The Right Shoes.
2008: Express Your Personality By Selecting The Right Accessories

A method of using a 4×4 color system uses color palates for better targeting of colors for clothing and décor selection for an individual. The 4×4 color system includes seasonal colors which are organized in 16 seasons. The 16 seasons include pure autumn, pure spring, pure summer, pure winter, shaded autumn, shaded spring, shaded summer, shaded winter, tinted autumn, tinted spring, tinted summer, tinted winter, toned autumn, toned spring, toned summer and toned winter. The traditional seasons of autumn, spring summer and winter each are further broken into pure, shaded, tinted and toned categories.

The method includes determining if the personality of an individual is active or passive by identifying skin color and personality DNA of the individual. The method includes using the active or passive determination and analyzing the undertone hue and intensity of the skin tones, hair color and eye color of the individual to provide color analysis results. The color analysis results are used to determine which one season of the 16 seasons matches the individual. The selected one season allows for better targeting of colors for clothing and décor selection for the individual.

In an example embodiment, a method of using a color classification system is provided. The color classification system includes categorized colors organized into 16 color categories.

In this example embodiment, the personality type of an individual is determined by identifying the individual's skin tone and personality characteristics. This determination may involve distinguishing whether the individual's personality type is active or passive.

The personality type determination is used in conjunction with an analysis of the skin undertone, skin tone intensity, individual's hair color, and individual's eye color to provide color matching results.

These color matching results are then used to determine which one out of the 16 color categories matches the individual. The color classification system may be a 4×4 color system.

The selected color category is used to better target colors for one or more apparel and one or more interior design elements selection for the individual. This may involve targeting colors for clothing selection or décor selection for the individual.

The color matching results are based on the analysis of the undertone hue and intensity of the skin tones, hair color, and eye color of the individual. These results may also be used to determine the season that matches the individual's personality and physical characteristics.

In another example embodiment, a system for using a color classification system is provided. This system includes a module for providing a color classification system, a module for determining the personality type of an individual, a module for using the personality type determination and analyzing the skin undertone, skin tone intensity, individual's hair color and individual's eye color to provide color matching results, a module for using the color matching results to determine which one out of 16 color categories matches the individual, and a module for using the selected color category to better target colors for one or more apparel and one or more interior design elements selection for the individual.

The color classification system may include seasonal colors organized in 16 seasons. The color matching results may be used to provide personalized color recommendations for the individual, including recommendations for clothing and décor selection.

This system and method provide a comprehensive and personalized approach to color selection, taking into account an individual's physical characteristics and personality type to provide targeted and effective color recommendations.

In one of the embodiments, the color classification system is a 4×4 color system. The personality type is the personality of an individual. The skin tone is the skin color. The personality characteristics is the personality DNA. The skin undertone is the undertone hue. The skin tone intensity is the intensity of the skin tones. The color matching results is the color analysis results. The color category is the one season. The apparel is the colors for clothing. The interior design elements is the colors for décor.

Providing a color classification system is providing a 4×4 color system. Determining the personality type is determining if the personality of an individual is active or passive. Identifying skin tone is identifying skin color. Identifying personality characteristics is identifying personality DNA. Analyzing skin undertone is analyzing the undertone hue. Analyzing skin tone intensity is analyzing the intensity of the skin tones. Providing color matching results is providing color analysis results. Using the color matching results is using the color analysis results. Selecting color category is determining which one season matches the individual. Using the selected color category is using the one season to better target colors for clothing and décor selection.

The colors presented in priority patent application 63/582,419 have been incorporated by reference and represent the preferred colors for using the methods described in this application.

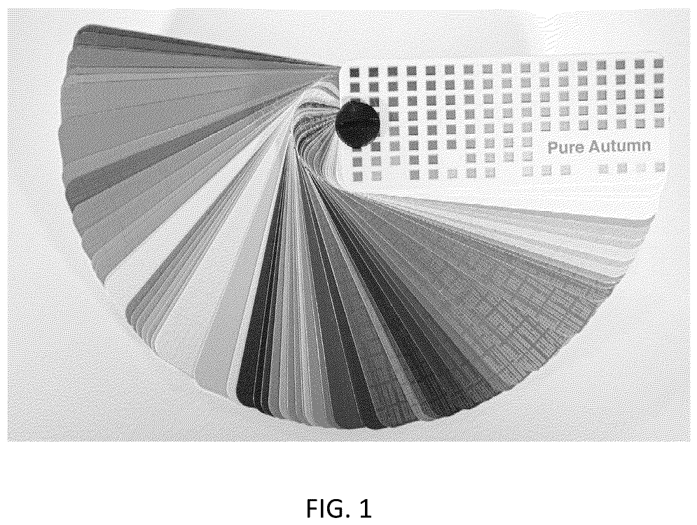

FIG. 1 is a black and white sample of one of the color palates filed in priority patent application 63/582,419 with corresponding color tabs in fan presentation.

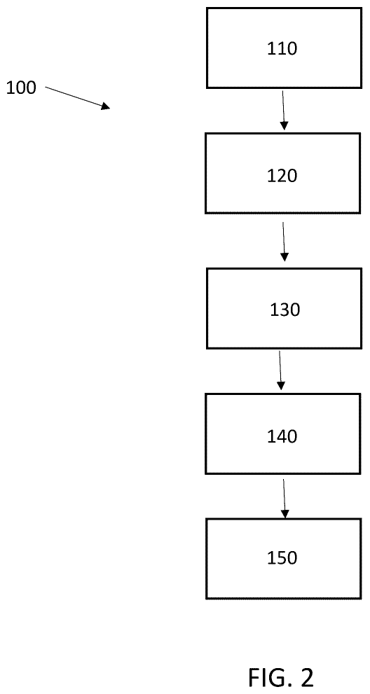

FIG. 2 is a flow chart of an example method 100 of using a 4×4 color system to determine the best colors for an individual's clothing and décor. The method 100 comprises providing a 4×4 color system including seasonal colors organized in 16 seasons in an operational block 110. The method 100 further comprises determining if the personality of an individual is active or passive by identifying skin color and personality DNA of the individual in an operational block 120. The method 100 further comprises using the active or passive determination and analyzing the undertone hue and intensity of the skin tones, hair color and eye color of the individual to provide color analysis results in operational block 130. The method 100 further comprises using the color analysis results to determine which one season of the 16 seasons matches the individual in an operational block 140. The method 100 further comprises using the one season to better target colors for clothing and décor selection for the individual in an operational block 150.

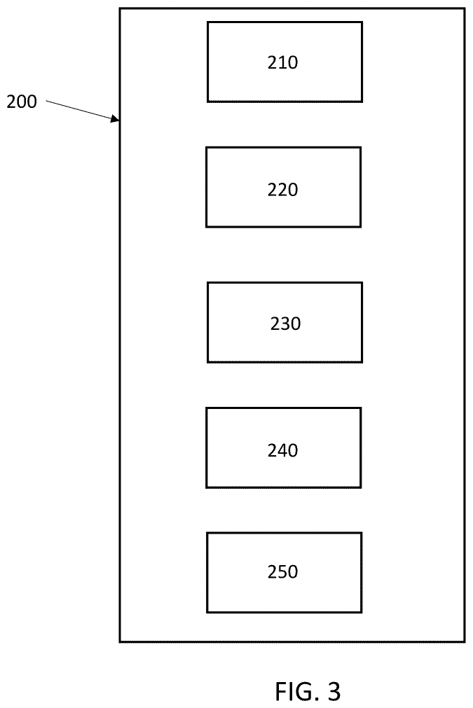

FIG. 3 is a diagram showing flow of a 4×4 color system 200 to determine the best colors for an individual's clothing and décor. The system 200 comprises a 4×4 color system 210 including seasonal colors organized in 16 seasons. The system 200 further comprises determining if the personality of an individual is active or passive by identifying skin color and personality DNA of the individual in an operational block 220. The system 200 includes determining if the personality type of an individual is active or passive in operational block 224. The system 200 further comprises using the active or passive determination and analyzing the undertone hue and intensity of the skin tones, hair color and eye color of the individual to provide color analysis results in operational block 230. The system 200 further comprises using the color analysis results to determine which one season of the 16 seasons matches the individual in an operational block 240. The system 200 further includes using the one season to better target colors for clothing and décor selection for the individual in an operational block 250.

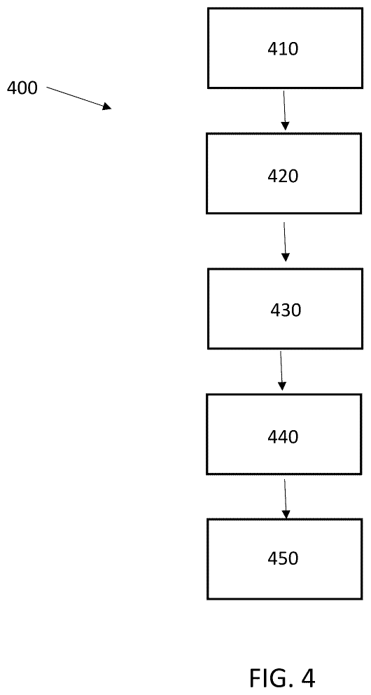

Another aspect of the present invention is directed to a method 400 of using a color classification system as shown in the flowchart of FIG. 4. The method 400 includes providing a color classification system including categorized colors organized in 16 color categories in operational block 410, selecting a personality type of an individual by identifying skin tone and personality characteristics of the individual in operational block 420, providing an analysis of skin undertone, skin tone intensity, hair color and eye color of the individual in operational block 430, using the personality type and the analysis for determining a target color category of the 16 colors categories matches the individual in operational block 440 and using the color classification system for implementing the target category for color selection for the individual in operational block 450. In one aspect, the method is replicable and teachable method of using a color classification system. In one aspect, the method is taught to trainees for management or customer care. In one aspect, the method is replicated in a franchise. In one aspect, the target color category is used to target colors for one or more apparel. In one aspect, the target color category is used to target colors for one or more interior design elements selection for the individual. In one aspect, the personality type of an individual is determined as active or passive and the method includes using the active or passive determination in analyzing the undertone hue and intensity of the skin tones, hair color and eye color of the individual to provide color analysis results. In one aspect, the color classification system is a 4×4 color system. In one aspect, the color matching results is based on the analysis of the undertone hue and intensity of the skin tones, hair color and eye color of the individual. In one aspect, the target color category is used to determine season matches for the individual's personality and physical characteristics. In one aspect, the color classification system includes seasonal colors organized in 16 seasons. In one aspect, the color matching results is used to provide personalized color recommendations for the individual. The steps of selecting a personality type of an individual by identifying skin tone and personality characteristics of the individual and providing an analysis of skin undertone, skin tone intensity, hair color and eye color of the individual may be reversed.

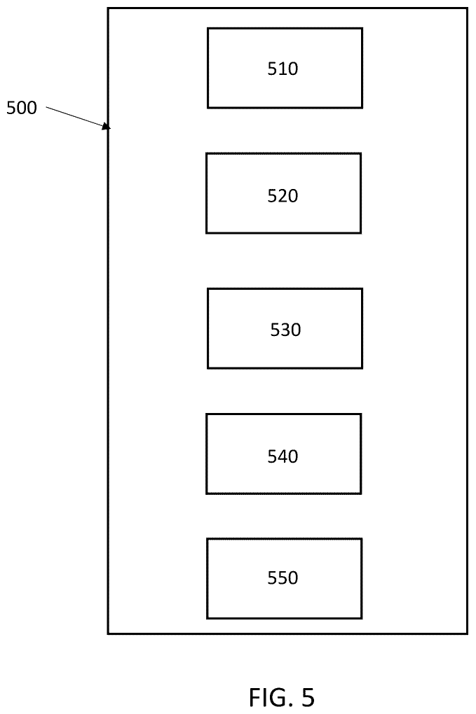

Another embodiment of the present invention is directed to a system 500 for using a color classification system as shown in the diagram of FIG. 5. The system 500 includes a module 510 for providing a color classification system including categorized colors organized in 16 color categories, a module 520 for determining the personality type of an individual by identifying the individual's skin tone and personality characteristics, a module 530 for using the personality type determination and analyzing the skin undertone, skin tone intensity, individual's hair color and individual's eye color to provide color matching results, a module 540 for using the color matching results to determine which one out of 16 color categories matches the individual and a module 550 for using the selected color category for targeted color selection for the individual. The system may target colors for one or more apparel and one or more interior design elements selection for the individual. The personality type of an individual may be determined as active or passive. The color classification system may be a 4×4 color system. The color matching results may be used to target colors for clothing selection for the individual. The color matching results may be used to target colors for décor selection for the individual. The color matching results may be based on the analysis of the undertone hue and intensity of the skin tones, hair color and eye color of the individual.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method of using a color classification system, comprising:
providing a color classification system including categorized colors organized in 16 color categories;
selecting a personality type of an individual by identifying skin tone and personality characteristics of the individual;
providing an analysis of skin undertone, skin tone intensity, hair color and eye color of the individual;
using the personality type and the analysis for determining a target color category of the 16 colors categories matches the individual; and
using the color classification system for implementing the target category for color selection for the individual.

2. The method of claim 1 wherein the method is a replicable and teachable method of using a color classification system.

3. The method of claim 2 wherein the method is taught to trainees for management or customer care.

4. The method of claim 2 wherein the method is replicated in a franchise.

5. The method of claim 1 wherein the target color category is used to target colors for one or more apparel.

6. The method of claim 1 wherein the target color category is used to target colors for one or more interior design elements selection for the individual.

7. The method of claim 1, wherein the personality type of an individual is determined as active or passive and wherein the method includes using the active or passive determination in analyzing the undertone hue and intensity of the skin tones, hair color and eye color of the individual to provide color analysis results.

8. The method of claim 1, wherein the color classification system is a 4×4 color system.

9. The method of claim 1, wherein the color matching results are based on the analysis of the undertone hue and intensity of the skin tones, hair color and eye color of the individual.

10. The method of claim 1, wherein the target color category is used to determine season matches for the individual's personality and physical characteristics.

11. The method of claim 1, wherein the color classification system includes seasonal colors organized in 16 seasons.

12. The method of claim 1, wherein the color matching results are used to provide personalized color recommendations for the individual.

13. A system for using a color classification system, comprising:
a module for providing a color classification system including categorized colors organized in 16 color categories;
a module for determining the personality type of an individual by identifying the individual's skin tone and personality characteristics;
a module for using the personality type determination and analyzing the skin undertone, skin tone intensity, individual's hair color and individual's eye color to provide color matching results;
a module for using the color matching results to determine which one out of 16 color categories matches the individual; and
a module for using the selected color category for targeted color selection for the individual.

14. The system of claim 13 wherein the system targets colors for one or more apparel and one or more interior design elements selection for the individual.

15. The system of claim 13, wherein the personality type of an individual is determined as active or passive.

16. The system of claim 13, wherein the color classification system is a 4×4 color system.

17. The system of claim 13, wherein the color matching results are used to target colors for clothing selection for the individual.

18. The system of claim 13, wherein the color matching results are used to target colors for décor selection for the individual.

19. The system of claim 13, wherein the color matching results are based on the analysis of the undertone hue and intensity of the skin tones, hair color and eye color of the individual.

20. A method of using a color classification system, comprising:
providing a color classification system including categorized colors organized in 16 color categories;
providing an analysis of skin undertone, skin tone intensity, hair color and eye color of the individual;
selecting a personality type of an individual by identifying skin tone and personality characteristics of the individual;
using the personality type and the analysis for determining a target color category of the 16 colors categories matches the individual; and
using the color classification system for implementing the target category for color selection for the individual.
